(19) United States
(12) Patent Application Publication
(10) Pub. No.: US 2026/0323221 A1
(43) Pub. Date: Oct. 15, 2026

(54) TRANSDUCER DEVICES AND SPEAKERS

(71) Applicants: SHENZHEN SHOKZ CO., LTD., Shenzhen (CN); SOUND SOLUTIONS (ZHENJIANG) INTERNATIONAL CO., LTD., Zhenjiang (CN)

(72) Inventors: Guangyuan ZHU, Shenzhen (CN); Lei ZHANG, Shenzhen (CN); Xin QI, Shenzhen (CN); Manuel MEFLEH, Vienna (AT); Christian KRONBICHLER, Vienna (AT)

(73) Assignees: SHENZHEN SHOKZ CO., LTD., Shenzhen (CN); SOUND SOLUTIONS (ZHENJIANG) INTERNATIONAL CO., LTD., Zhenjiang (CN)

(21) Appl. No.: 19/696,253

(22) Filed: Jun. 2, 2026

Related U.S. Application Data
(63) Continuation of application No. PCT/CN2025/119110, filed on Sep. 4, 2025.

(30) Foreign Application Priority Data
Dec. 13, 2024 (CN) 202411844311.6

(51) Int. Cl. H04R 9/02; H04R 9/06; H04R 9/18

(52) U.S. Cl. CPC H04R 9/025; H04R 9/06; H04R 9/18; H04R 2460/13

(57) ABSTRACT

The present disclosure relates to a transducer device and a speaker. The transducer device includes a first magnetic circuit assembly including a dynamic component and a static component, the dynamic component includes a first magnet and a magnetic conductive plate, the static component includes a magnetic conductive element at least partially surrounding the dynamic component; a voice coil assembly; a resilient plate assembly configured to allow the dynamic component to move relative to the static component in a first direction. An inner side surface of the magnetic conductive element facing the first magnet is provided with at least one protrusion, the at least one protrusion has magnetic permeability. The at least one protrusion includes a first protrusion and a third protrusion located at two sides of the magnetic conductive plate respectively in the first direction.

### CROSS-REFERENCE TO RELATED APPLICATIONS

This application is a continuation of International Application No. PCT/CN2025/119110, filed on Sep. 4, 2025, which claims priority to Chinese Patent Application No. 202411844311.6, filed on Dec. 13, 2024, the entire contents of each of which are incorporated herein by reference.

### TECHNICAL FIELD

The present disclosure relates to the field of acoustic technology, and in particular, to a transducer device and a speaker.

### BACKGROUND

With the development of acoustic output technology, speakers are widely used in people's daily lives. The speakers can be used in conjunction with electronic devices such as mobile phones and computers to provide an auditory feast for users. In a speaker, to ensure that the speaker has good output performance across the full frequency band, the vibration structure of the speaker generally needs to be designed so that the speaker has a strong driving force while also having a resonance frequency in the mid-to-low frequency range, thereby achieving high sensitivity and good output performance in the mid-to-low frequency range.

### SUMMARY

One or more embodiments of the present disclosure provide a transducer device. The transducer device includes a first magnetic circuit assembly, a voice coil assembly, and a resilient plate assembly. The first magnetic circuit assembly includes a dynamic component and a static component. The dynamic component includes a first magnet and a magnetic conductive plate, and the static component includes a magnetic conductive element at least partially surrounding the dynamic component. The voice coil assembly is fixed to the static component. The voice coil assembly is at least partially located in a magnetic gap between the static component and the dynamic component. The dynamic component is movable relative to the voice coil assembly and the static component. The voice coil assembly includes at least one voice coil. The resilient plate assembly is configured to connect the dynamic component and the static component. The resilient plate assembly allows the dynamic component to move relative to the static component in a first direction. The first direction is parallel to an axis of the voice coil assembly. An inner side surface of the magnetic conductive element facing the first magnet is provided with at least one protrusion. The at least one protrusion is arranged in a staggered manner with the voice coil assembly in the first direction. The at least one protrusion has magnetic permeability. The magnetic conductive plate is disposed on a surface of the first magnet along the first direction. The at least one protrusion includes a first protrusion and a third protrusion. The first protrusion and the third protrusion are arranged at an interval in the first direction. In the first direction, the first protrusion and the third protrusion are respectively located at two sides of the magnetic conductive plate.

One or more embodiments of the present disclosure provide a speaker. The speaker includes a transducer device as described above.

### BRIEF DESCRIPTION OF THE DRAWINGS

The present disclosure will be further described by way of exemplary embodiments, which will be described in detail with reference to the drawings. These embodiments are not limiting, and in these embodiments, the same reference numerals denote the same structures, wherein:

FIG. 1 is a schematic diagram illustrating a structure of a bone conduction speaker according to some embodiments of the present disclosure;

FIG. 2 is a schematic diagram illustrating a structure of a transducer device according to some embodiments of the present disclosure;

FIG. 3A and FIG. 3B are schematic diagrams illustrating positions of movement of a dynamic component according to some embodiments of the present disclosure;

FIG. 4 is a schematic diagram illustrating another structure of the transducer device according to some embodiments of the present disclosure; and

FIG. 5 is a schematic diagram illustrating yet another structure of the transducer device according to some embodiments of the present disclosure.

### DETAILED DESCRIPTION

To more clearly illustrate the technical solutions of the embodiments of the present disclosure, a brief introduction to the accompanying drawings to be used in the description of the embodiments is provided below. Evidently, the accompanying drawings in the following description are merely some examples or embodiments of the present disclosure. For those skilled in the art, without making creative efforts, the present disclosure may also be applied to other similar scenarios based on the accompanying drawings. It should be understood that these exemplary embodiments are given merely to enable those skilled in the art to better understand and implement the present disclosure, and are not intended to limit the scope of the present disclosure in any way. Unless explicitly indicated otherwise by the context or otherwise specified, the same reference signs in the drawings represent the same structures or operations.

As shown in the present disclosure and the claims, unless the context clearly indicates an exception, words such as “a”, “an”, “one”, and/or “the” are not specifically limited to the singular, and may also include the plural. Generally speaking, the terms “comprising” and “including” merely indicate the inclusion of explicitly identified steps and elements, and these steps and elements do not constitute an exhaustive list, and a method or an apparatus may also include other steps or elements. The term “based on” refers to “at least partially based on”. The term “an embodiment” refers to “at least one embodiment”; and the term “another embodiment” refers to “at least one additional embodiment”.

In the description of the present disclosure, it should be understood that the positional or orientation relationships indicated by terms such as “front”, “rear”, or the like, are based on the positional or orientation relationships shown in the accompanying drawings, and are merely for the convenience of describing the present disclosure and simplifying the description, and are not to indicate or imply that an apparatus or an element referred to must have a specific orientation, or be constructed and operated in a specific orientation. Therefore, these should not be understood as a limitation on the present disclosure.

Furthermore, the terms “first” and “second” are merely for descriptive purposes, and should not be understood as indicating or implying relative importance or implicitly indicating the number of the technical features indicated. Thus, a feature defined with “first” or “second” may explicitly or implicitly include at least one such feature. In the description of the present disclosure, the term “a plurality of” means at least two, for example, two, three, or the like, unless otherwise expressly and specifically limited.

In the present disclosure, unless otherwise expressly provided and defined, the terms “mounted”, “coupled”, “connected”, “fixed”, or the like, should be broadly understood. For example, these may be fixed connections, detachable connections, or integrated into one unit; these may be mechanical connections, or electrical connections; these may be directly coupled, or indirectly coupled through an intermediate medium; these may be internal communication between two elements or an interactive relationship between two elements, unless otherwise expressly limited. For those skilled in the art, the specific meaning of the above terms in the present disclosure may be understood according to specific circumstances.

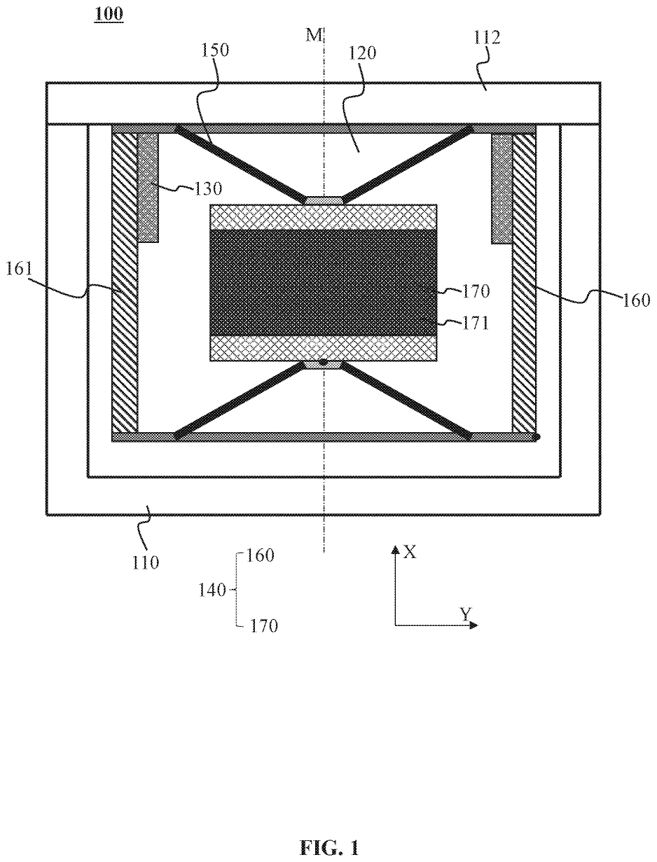

FIG. 1 is a schematic diagram illustrating a structure of a speaker according to some embodiments of the present disclosure. As shown in FIG. 1, some embodiments of the present disclosure provide a speaker 100, which includes a housing 110 and a transducer device 120. The transducer device 120 is configured to vibrate to generate a sound and transmit the sound to a user through the housing 110.

In some embodiments, the speaker 100 may be an air conduction speaker. Correspondingly, the transducer device 120 may be an air conduction transducer device. The housing 110 may be provided with a sound hole (not shown in the figure) acoustically coupled to the transducer device 120. One end of the transducer device 120 in a vibration direction may be connected to a diaphragm. The transducer device 120 drives the diaphragm to vibrate to generate an air conduction sound. The air conduction sound is transmitted to an ear canal opening of the user through the sound hole, so that the user receives the air conduction sound.

In some embodiments, as shown in FIG. 1, the speaker 100 may be a bone conduction speaker. Correspondingly, the transducer device 120 may be a bone conduction transducer device. The housing 110 may include a vibration panel 112 configured to fit a face of the user. The transducer device 120 is connected to the vibration panel 112, and the transducer device 120 is configured to drive the vibration panel 112 to vibrate, so that the vibration panel 112 generates a bone conduction sound. In a wearing state, the vibration panel 112 transmits the bone conduction sound through the face to a cochlea of the user, so that the user receives the bone conduction sound.

In some embodiments, the speaker 100 may be a speaker combining bone conduction and air conduction, and a count of transducer devices 120 may be one or more. When the count of the transducer device 120 is one, the housing 110 may include the vibration panel 112, and the housing 110 is provided with the sound hole. The transducer device 120 may drive the diaphragm to vibrate to generate the air conduction sound, and simultaneously drive the vibration panel 112 to vibrate to generate the bone conduction sound. When there are a plurality of transducer devices 120, at least one of the plurality of transducer devices 120 may be an air conduction transducer device configured to drive the diaphragm to vibrate to generate the air conduction sound, and at least another one of the plurality of transducer devices 120 is a bone conduction transducer device configured to drive the vibration panel 112 to vibrate to generate the bone conduction sound.

In some embodiments, the transducer device 120 includes a voice coil assembly 130, a first magnetic circuit assembly 140, and a resilient plate assembly 150.

The first magnetic circuit assembly 140 includes a static component 160 and a dynamic component 170. The dynamic component 170 includes a first magnet 171, and the static component 160 includes a magnetic conductive element 161 at least partially surrounding the dynamic component 170 (e.g., the first magnet 171). The magnetic conductive element 161 is configured to conduct a magnetic field generated by the dynamic component 170 (e.g., the first magnet 171).

The voice coil assembly 130 is fixed to the static component 160, and at least a portion of the voice coil assembly 130 is located in a magnetic gap between the static component 160 and the dynamic component 170 (e.g., a magnetic gap formed between the magnetic conductive element 161 and the dynamic component 170). The dynamic component 170 is movable relative to the voice coil assembly 130 and the static component 160. The voice coil assembly 130 includes at least one voice coil, and a direction of an axis M of the voice coil assembly 130 is consistent with a vibration direction of the transducer device 120. In some embodiments, the voice coil assembly 130 may include two voice coils. The two voice coils are respectively located at least partially in magnetic gaps at two ends of the transducer device 120 in the vibration direction.

The resilient plate assembly 150 is configured to connect the dynamic component 170 and the static component 160, and to allow the dynamic component 170 and the static component 160 to move relative to each other in a first direction X. The first direction X is parallel to the axis M. In some embodiments, the static component 160 is connected to the housing 110, and the dynamic component 170 may vibrate relative to the static component 160 and the housing 110. During a movement of the dynamic component 170 relative to the static component 160, the resilient plate assembly 150 provides a first restoring force that restores the dynamic component 170 to a balanced position. The first magnetic circuit assembly 140 (e.g., the static component 160) provides a second restoring force that restores the dynamic component 170 to the balanced position. The first restoring force and the second restoring force enable the dynamic component 170 to have a tendency to return to the balanced position. The first restoring force provided by the resilient plate assembly 150 may interact with the second restoring force provided by the first magnetic circuit assembly 140 to jointly adjust the vibration difficulty of the dynamic component 170, thereby adjusting the driving force of the transducer device 120, and adjusting the output performance of the speaker 100. The balanced position refers to a relative position of the dynamic component 170 and the static component 160 when the voice coil assembly 130 is not energized.

In some embodiments, one end of the transducer device 120 in the vibration direction may be connected to the housing 110 to fix the transducer device 120. In some embodiments, the two ends of the transducer device 120 in the vibration direction may be respectively connected to the housing 110 to fix the transducer device 120. In some embodiments, an outer side surface of the transducer device 120 (e.g., an outer side surface of the static component 160 or the magnetic conductive element 161) may be connected to the housing 110 to fix the transducer device 120.

In order to prevent an excessive moving range of the dynamic component 170, which may lead to interference between the dynamic component 170 and other components (e.g., a vibration transmission plate, the housing 110, or the like) and affect normal use, in some embodiments, in the first direction X, a moving distance of the dynamic component 170 relative to the balanced position is in a range of 0 mm to 1.0 mm. It should be noted that, the moving distance of the dynamic component 170 relative to the balanced position in the first direction X is in a range of 0 mm to 1.0 mm, meaning that an upward moving distance of the dynamic component 170 relative to the balanced position along the first direction X does not exceed 1.0 mm, and a downward moving distance along the first direction X does not exceed 1.0 mm. In some embodiments, to further prevent the interference between the dynamic component 170 and other components, in the first direction X, the moving distance of the dynamic component 170 relative to the balanced position is in a range of 0 mm to 0.8 mm.

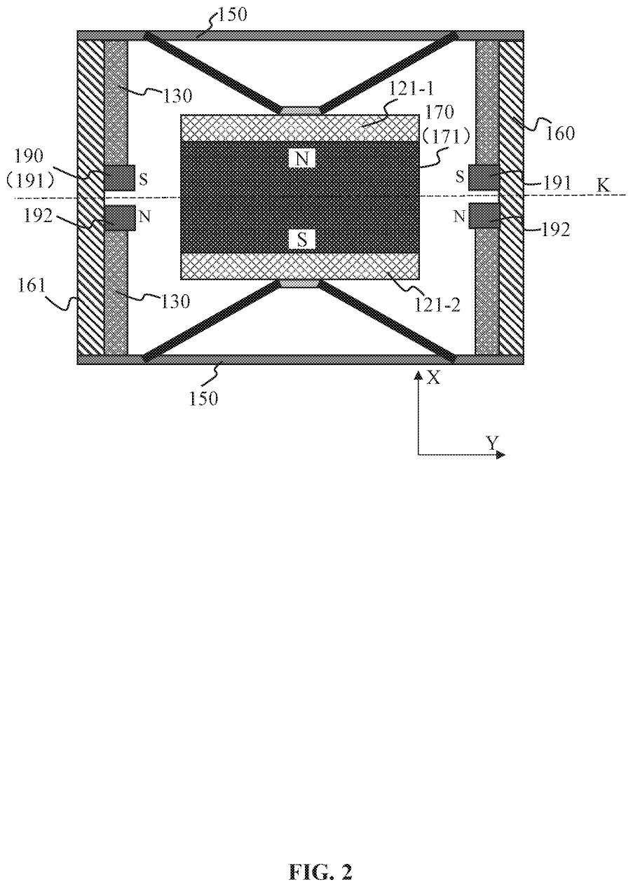

In some embodiments, to reduce an F0 characteristic resonance frequency of the transducer device 120 and improve the output performance of the speaker 100, the transducer device 120 may be designed to improve the driving force of the transducer device 120. For example, a protrusion (e.g., a protrusion 190, referring to FIG. 2) may be designed on the static component 160 (e.g., the magnetic conductive element 161). The protrusion provides a compensating force that makes the dynamic component 170 deviate from the balanced position to partially offset the restoring forces provided by the first magnetic circuit assembly 140 and the resilient plate assembly 150 that restore the dynamic component 170 to the balanced position, thereby reducing the moving difficulty of the dynamic component 170 and further improving the driving force of the transducer device 120.

In some embodiments, the resilient plate assembly 150 allows the dynamic component 170 to vibrate relative to the static component 160 and the housing 110. The vibration produces at least one resonance peak within a frequency range of 100 Hz to 200 Hz. That is, the output of the speaker 100 (the transducer device 120) includes at least one resonance peak with a frequency in a range of 100 Hz to 200 Hz, thereby improving the output of the speaker 100 in a mid-low frequency band (e.g., a frequency band below 250 Hz), so that the speaker 100 has the better output performance in the mid-low frequency band.

FIG. 2 is a schematic diagram illustrating a structure of a transducer device according to some embodiments of the present disclosure.

Referring to FIG. 2, in some embodiments, an inner side surface of the magnetic conductive element 161 facing the first magnet 171 is provided with at least one protrusion 190. The at least one protrusion 190 is arranged in a staggered manner with the voice coil assembly 130 in the first direction X, to avoid interference between the protrusion 190 and the voice coil assembly 130. In some embodiments, the protrusion 190 and the magnetic conductive element 161 may be an integrated structure made of the same material, or may be an assembled structure made of the same material or different materials. For example, the protrusion 190 may be a magnetic conductive material and integrally formed with the magnetic conductive element 161. As another example, the protrusion 190 may be a magnetic conductive material and assembled to the magnetic conductive element 161. For a further example, the protrusion 190 may be a magnet and assembled to the magnetic conductive element 161.

In some embodiments, the at least one protrusion 190 may abut the voice coil assembly 130 in the first direction X, so that the protrusion 190 supports the voice coil assembly 130 in the vibration direction of the voice coil assembly 130 (i.e., the first direction X) to improve stability of the voice coil assembly 130. Specifically, an end of the voice coil assembly 130 extending into the magnetic gap may abut a side surface of the protrusion 190 in the first direction X, as shown in FIG. 2. In some embodiments, a gap may also be present between the end of the voice coil assembly 130 extending into the magnetic gap and the side surface of the protrusion 190 in the first direction X.

In some embodiments, the at least one protrusion 190 has magnetic permeability. During a movement of the dynamic component 170 relative to the static component 160, the first magnetic circuit assembly 140 provides the second restoring force to restore the dynamic component 170 to the balanced position, and the resilient plate assembly 150 provides the first restoring force to restore the dynamic component 170 to the balanced position. The at least one protrusion 190 interacts with the first magnet 171 to provide a force that causes the dynamic component 170 to deviate from the balanced position. That is, the at least one protrusion 190 interacts with the first magnetic circuit assembly 140 to provide the compensation force that causes the dynamic component 170 to deviate from the balanced position. In this case, the first restoring force provided by the resilient plate assembly 150 may interact with the compensation force jointly provided by the at least one protrusion 190 and the magnetic conductive element 161 to jointly adjust the vibration difficulty of the dynamic component 170, thereby adjusting a driving force of the transducer device 120, adjusting F0 characteristics of the transducer device 120, and adjusting output performance of the speaker 100. For more details about interaction processes of the first magnetic circuit assembly 140 and the protrusion 190, please refer to subsequent relevant descriptions.

Referring to FIG. 2, in some embodiments, the dynamic component 170 of the speaker 100 includes a first magnetic conductive plate 121-1 and a second magnetic conductive plate 121-2. The first magnetic conductive plate 121-1 and the second magnetic conductive plate 121-2 are respectively arranged at two ends of the first magnet 171 along the first direction X. Illustratively, the first magnetic conductive plate 121-1 may be arranged at an upper end (an upper side surface) of the first magnet 171, and the second magnetic conductive plate 121-2 may be arranged at a lower end (a lower side surface) of the first magnet 171. The first magnetic conductive plate 121-1 and the second magnetic conductive plate 121-2 are configured to internally conduct a magnetic field generated by the first magnet 171. In this case, the resilient plate assembly 150 includes a first vibration transmission plate and a second vibration transmission plate. The first vibration transmission plate is connected to a first end of the dynamic component 170 along the first direction X, and the second vibration transmission plate is connected to a second end of the dynamic component 170 along the first direction X. The voice coil assembly 130 includes a first voice coil and a second voice coil. At least a portion of the first voice coil is located in a region of the magnetic gap corresponding to the first end of the dynamic component 170 along the first direction X, and at least a portion of the second voice coil is located in a region of the magnetic gap corresponding to the second end of the dynamic component 170 along the first direction X. In some embodiments, when the resilient plate assembly 150 includes only one vibration transmission plate, the first magnetic circuit assembly 140 may include only one magnetic conductive plate 121, and the voice coil assembly 130 may include only one corresponding voice coil.

Referring to FIG. 2, in some embodiments, the at least one protrusion 190 may include a first protrusion 191 and a second protrusion 192. The first protrusion 191 and the second protrusion 192 are arranged at an interval from each other along the first direction X. In the first direction X, both the first protrusion 191 and the second protrusion 192 are located between the first magnetic conductive plate 121-1 and the second magnetic conductive plate 121-2. In the first direction X, the first protrusion 191 is closer to the first magnetic conductive plate 121-1 than the second protrusion 192, and the second protrusion 192 is closer to the second magnetic conductive plate 121-2 than the first protrusion 191. A polarity of a side of the first magnet 171 facing the first magnetic conductive plate 121-1 along the first direction X (the upper side surface) is opposite to a polarity of a side of the first protrusion 191 facing the dynamic component 170 along a second direction Y, and a polarity of a side of the first magnet 171 facing the second magnetic conductive plate 121-2 along the first direction X (the lower side surface) is opposite to a polarity of a side of the second protrusion 192 facing the dynamic component 170 along the second direction Y. Illustratively, as shown in FIG. 2, the upper side surface of the first magnet 171 is an N-pole, the side of the first protrusion 191 facing the dynamic component 170 along the second direction Y is an S-pole, and the first protrusion 191 and the upper side surface of the first magnet 171 attract each other. The lower side surface of the first magnet 171 is an S-pole, the side of the second protrusion 192 facing the dynamic component 170 along the second direction Y is an N-pole, and the second protrusion 192 and the lower side surface of the first magnet 171 attract each other.

In some embodiments, the first magnetic conductive plate 121-1 and the second magnetic conductive plate 121-2 arranged at two ends of the first magnet 171 along the first direction X are symmetrical based on a first reference plane K. The first reference plane K may be a centerline plane of the first magnet 171 parallel to the second direction Y. In some embodiments, the first protrusion 191 and the second protrusion 192 are also symmetrical based on the first reference plane K, so that a distance from the first protrusion 191 to the first magnetic conductive plate 121-1 is the same as a distance from the second protrusion 192 to the second magnetic conductive plate 121-2. That is, a distance from the first protrusion 191 to the upper side surface of the first magnet 171 is the same as a distance from the second protrusion 192 to the lower side surface of the first magnet 171. This allows the force of the first protrusion 191 on the first magnet 171 and the force of the second protrusion 192 on the first magnet 171 to better cancel each other out, to keep the first magnet 171 in the balanced position.

Referring to FIG. 2, when the dynamic component 170 is in the balanced position, the first protrusion 191 is closer to the upper side surface of the first magnet 171 and further away from the lower side surface of the first magnet 171, and the first protrusion 191 provides a downward force on the first magnet 171 along the first direction X; the second protrusion 192 is further away from the upper side surface of the first magnet 171 and closer to the lower side surface of the first magnet 171, and the second protrusion 192 provides an upward force on the first magnet 171 along the first direction X. The force of the first protrusion 191 on the first magnet 171 and the force provided by the second protrusion 192 on the first magnet 171 may cancel each other out to maintain the dynamic component 170 in the balanced position.

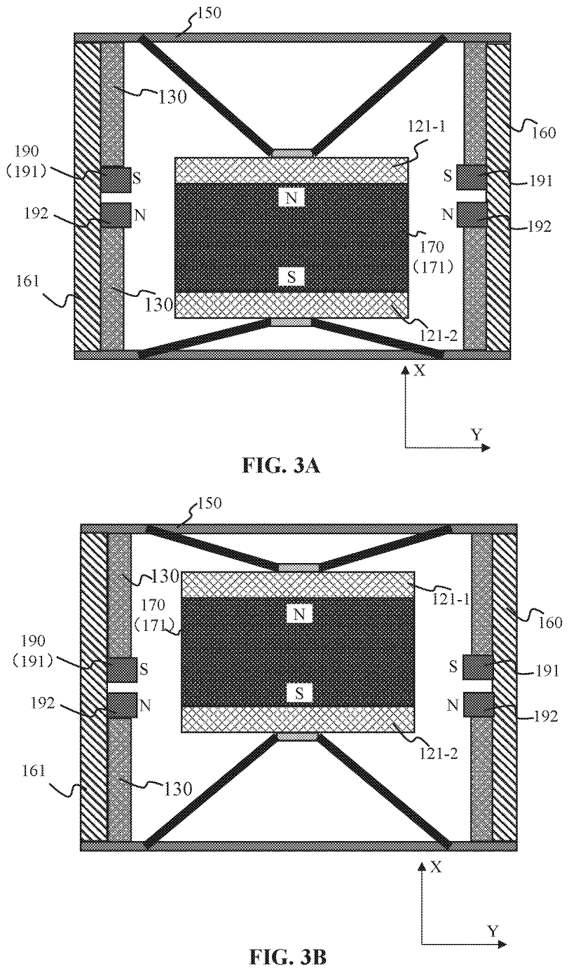

FIG. 3A and FIG. 3B are schematic diagrams illustrating positions of movement of a dynamic component according to some embodiments of the present disclosure.

Referring to FIG. 2 and FIG. 3A, when the dynamic component 170 moves downward relative to the static component 160 in the first direction X as shown in FIG. 3A, the distance between the first protrusion 191 and the upper side surface of the first magnet 171 decreases, the distance between the first protrusion 191 and the lower side surface of the first magnet 171 increases, and a magnitude of the downward force provided by the first protrusion 191 on the first magnet 171 along the first direction X increases. The distance between the second protrusion 192 and the upper side surface of the first magnet 171 decreases, the distance between the second protrusion 192 and the lower side surface of the first magnet 171 increases, and a magnitude of the upward force provided by the second protrusion 192 on the first magnet 171 along the first direction X decreases. That is, a resultant downward force provided by the first protrusion 191 and the second protrusion 192 on the first magnet 171 along the first direction X is in the same direction as the moving direction of the dynamic component 170, pointing away from the balanced position.

Referring to FIG. 2 and FIG. 3B, when the dynamic component 170 moves upward relative to the static component 160 in the first direction X as shown in FIG. 3B, the distance between the first protrusion 191 and the upper side surface of the first magnet 171 increases, the distance between the first protrusion 191 and the lower side surface of the first magnet 171 decreases, and the magnitude of the downward force provided by the first protrusion 191 on the first magnet 171 along the first direction X decreases. The distance between the second protrusion 192 and the upper side surface of the first magnet 171 increases, the distance between the second protrusion 192 and the lower side surface of the first magnet 171 decreases, and the magnitude of the upward force provided by the second protrusion 192 on the first magnet 171 along the first direction X increases. That is, a resultant upward force provided by the first protrusion 191 and the second protrusion 192 on the first magnet 171 along the first direction X is in the same direction as the moving direction of the dynamic component 170, pointing away from the balanced position.

The size of the protrusion 190 may affect magnetic strength of the protrusion 190, thereby affecting the force of the protrusion 190 on the first magnet 171, further affecting moving capability of the dynamic component 170, affecting the driving force of the transducer device 120, and affecting the output performance of the speaker 100. In some embodiments, to make the magnitude of the force of the protrusion 190 on the first magnet 171 appropriate, a height of the at least one protrusion 190 (e.g., the first protrusion 191, the second protrusion 192, a third protrusion 193, or the like) along the first direction X is in a range of 0.1 mm to 0.4 mm, and a width along the second direction Y is in a range of 0.1 mm to 0.5 mm. In some embodiments, to further ensure the output performance of the speaker 100, the height of the at least one protrusion 190 along the first direction X may be in a range of 0.2 mm to 0.3 mm, and the width along the second direction Y may be in a range of 0.3 mm to 0.4 mm.

The distance between the protrusion 190 and the first magnet 171 in the second direction Y may affect the magnitude of the force of the protrusion 190 on the first magnet 171. When the distance is too large, the corresponding force is relatively small, and the improvement effect on the output performance of the speaker 100 is relatively weak. When the distance is too small, the protrusion 190 may interfere with the first magnet 171, and may affect the movement of the first magnet 171. The distance between the protrusion 190 and the first magnet 171 in the second direction Y refers to a distance in the second direction Y between a side of the protrusion 190 facing the first magnet 171 along the second direction Y and a side of the first magnet 171 facing the protrusion 190 along the second direction Y.

In some embodiments, to improve the output performance of the speaker 100 and ensure the normal operation of the speaker 100, in the second direction Y, the distance between a side surface of the at least one protrusion 190 facing the first magnet 171 and a side surface of the magnetic conductive plate 121 facing the magnetic conductive element 161 is in a range of 0.2 mm to 0.6 mm. In some embodiments, to further improve the output performance of the speaker 100, the distance between the at least one protrusion 190 and the first magnet 171 in the second direction Y is in a range of 0.3 mm to 0.5 mm.

In some embodiments, to improve the output performance of the speaker 100 and ensure the normal operation of the speaker 100, in the second direction Y, a ratio of the distance between the side surface of the at least one protrusion 190 facing the first magnet 171 and the side surface of the magnetic conductive plate 121 facing the magnetic conductive element 161 to the distance between the inner side surface of the magnetic conductive element 161 and the side surface of the magnetic conductive plate 121 facing the magnetic conductive element 161 (i.e., a width dimension of the magnetic gap in the second direction Y) is 0.29 to 0.86. In some embodiments, to further improve the output performance of the speaker 100, in the second direction Y, the ratio of the distance between the side surface of the at least one protrusion 190 facing the first magnet 171 and the side surface of the magnetic conductive plate 121 facing the magnetic conductive element 161 to the distance between the inner side surface of the magnetic conductive element 161 and the side surface of the magnetic conductive plate 121 facing the magnetic conductive element 161 (i.e., the width dimension of the magnetic gap in the second direction Y) is 0.4 to 0.7.

In some embodiments, to improve the output performance of the speaker 100 and ensure the normal operation of the speaker 100, in the second direction Y, a ratio of a width of the at least one protrusion 190 to the distance between the inner side surface of the magnetic conductive element 161 and the side surface of the magnetic conductive plate 121 facing the magnetic conductive element 161 (i.e., the width dimension of the magnetic gap in the second direction Y) may be 0.14 to 0.71. In some embodiments, to further improve the output performance of the speaker 100, in the second direction Y, the ratio of the width of the at least one protrusion 190 to the distance between the inner side surface of the magnetic conductive element 161 and the side surface of the magnetic conductive plate 121 facing the magnetic conductive element 161 (i.e., the width dimension of the magnetic gap in the second direction Y) may be 0.3 to 0.6.

If the distance between the protrusion 190 and the corresponding magnetic conductive plate in the first direction X is too small, it may cause a portion of the voice coil assembly 130 extending into the magnetic gap to be too small, which may lead to the relatively small driving force of the voice coil assembly 130, and may affect the output of the speaker 100. If the distance between the protrusion 190 and the corresponding magnetic conductive plate in the first direction X is too large, it may cause the force of the protrusion 190 on the first magnet 171 to be too small, thereby affecting the driving force of the transducer device 120 and the output performance of the speaker 100. The distance between the protrusion 190 and the corresponding magnetic conductive plate in the first direction X refers to a distance in the first direction X between a side surface of the protrusion 190 facing the corresponding magnetic conductive plate in the first direction X and a side surface of the corresponding magnetic conductive plate facing the first magnet 171 in the first direction X; or a distance in the first direction X between a centerline plane of the protrusion 190 parallel to the second direction Y and a centerline plane of the corresponding magnetic conductive plate parallel to the second direction Y. For example, the distance between the protrusion 190 and the corresponding magnetic conductive plate in the first direction X may be a distance between an upper side surface of the first protrusion 191 and a lower side surface of the first magnetic conductive plate 121-1, or a distance in the first direction X between a centerline plane of the first protrusion 191 parallel to the second direction Y and a centerline plane of the first magnetic conductive plate 121-1 parallel to the second direction Y.

In some embodiments, to ensure the output performance of the speaker 100, a distance between the first protrusion 191 and the first magnetic conductive plate 121-1 in the first direction X is 1.01 mm to 1.50 mm, and a distance between the second protrusion 192 and the second magnetic conductive plate 121-2 in the first direction X is 1.01 mm to 1.50 mm. In some embodiments, to further improve the output performance of the speaker 100, the distance between the first protrusion 191 and the first magnetic conductive plate 121-1 in the first direction X is 1.2 mm to 1.3 mm, and the distance between the second protrusion 192 and the second magnetic conductive plate 121-2 in the first direction X is 1.2 mm to 1.3 mm.

If two adjacent protrusions 190 are too close to each other, the two protrusions 190 may be approximately regarded as a single protrusion 190. During the movement of the dynamic component 170, to enable the protrusion 190 to provide the compensation force directed away from the balanced position to the dynamic component 170, the distance between the protrusion 190 and the first magnetic conductive plate 121-1 and the distance between the protrusion 190 and the second magnetic conductive plate 121-2 need to have a larger difference, so as to avoid the forces of the protrusion 190 on the upper side surface and the lower side surface of the first magnet 171 cancelling each other out. That is, the protrusion 190 needs to have a relatively large height in the first direction X, so as to make the distance between the protrusion 190 and the first magnetic conductive plate 121-1 and the distance between the protrusion 190 and the second magnetic conductive plate 121-2 have a relatively large difference. If two adjacent protrusions 190 are too far apart, it may cause the distance between the protrusion 190 and the corresponding magnetic conductive plate in the first direction X to be too small, which may cause the portion of the voice coil assembly 130 extending into the magnetic gap to be too small, which may lead to the relatively small driving force of the voice coil assembly 130, and may affect the output of the bone conduction speaker 100. The interval between any two adjacent protrusions 190 in the first direction X refers to a distance between two opposite surfaces of the two protrusions 190 in the first direction X.

In some embodiments, to ensure the output of the speaker 100, a ratio of the interval between any two adjacent protrusions 190 in the at least one protrusion 190 in the first direction X to the height of the protrusion 190 in the first direction X is 0.1 to 1. In some embodiments, to further improve the output of the speaker 100, the ratio of the interval between any two adjacent protrusions 190 in the at least one protrusion 190 in the first direction X to the height of the protrusion 190 in the first direction X is 0.2 to 0.8.

In some embodiments, the first protrusion 191 is provided with a first boss (not shown in the figure) at a free end thereof facing the first magnet 171 along the second direction Y, the first boss points to the first magnetic conductive plate 121-1 along the first direction X; and the second protrusion 192 is provided with a second boss (not shown in the figure) at a free end thereof facing the first magnet 171 along the second direction Y, and the second boss points to the second magnetic conductive plate 121-2 along the first direction X. The arrangement of the boss may make the distance between the corresponding protrusion and the corresponding magnetic conductive plate in the first direction X smaller, thereby increasing the magnitude of the force exerted by the corresponding protrusion on the first magnet 171, thereby increasing the magnitude of the compensation force provided by the magnetic conductive element 161 and directed away from the balanced position to the dynamic component 170, and increasing the output performance of the speaker 100.

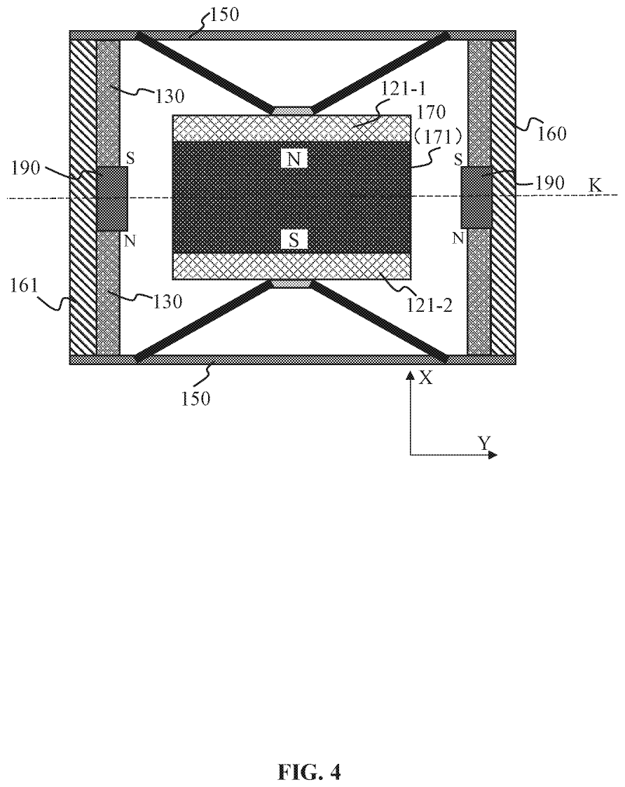

FIG. 4 is a schematic diagram illustrating another structure of the transducer device according to some embodiments of the present disclosure. Please refer to FIG. 4, in some embodiments, the at least one protrusion 190 may only include a single protrusion, the single protrusion is arranged between the first magnetic conductive plate 121-1 and the second magnetic conductive plate 121-2, and the single protrusion is symmetrical based on the first reference plane K. That is, at this time, the single protrusion may be regarded as a case where the interval between the first protrusion 191 and the second protrusion 192 is 0. In some embodiments, to enable the single protrusion to provide the compensation force directed away from the balanced position to the dynamic component 170, a polarity of a side of the single protrusion facing the first magnetic conductive plate 121-1 in the first direction X is opposite to the polarity of the side of the first magnet 171 facing the first magnetic conductive plate 121-1 in the first direction X, and a polarity of a side of the single protrusion facing the second magnetic conductive plate 121-2 in the first direction X is opposite to the polarity of the side of the first magnet 171 facing the second magnetic conductive plate 121-2 in the first direction X.

A size of the single protrusion may reflect the magnetic strength of the single protrusion, thereby affecting the force of the single protrusion on the first magnet 171, further affecting the moving ability of the dynamic component 170, affecting the driving force of the transducer device 120, and affecting the output performance of the speaker 100. In some embodiments, to make the single protrusion have an appropriate magnetic strength, so as to enable the single protrusion to provide the compensation force of an appropriate magnitude to the dynamic component 170, a width of the single protrusion along the second direction Y is 0.2 mm to 0.5 mm. In some embodiments, to enable the single protrusion to provide the compensation force of an appropriate magnitude to the dynamic component 170, the width of the single protrusion along the second direction Y is 0.3 mm to 0.4 mm.

The height of the single protrusion along the first direction X may, to some extent, reflect a distance between the single protrusion and the corresponding magnetic conductive plate in the first direction X, and a distance between the single protrusion and the corresponding magnetic conductive plate in the first direction X may affect the magnitude of the compensation force provided by the single protrusion to the dynamic component 170, further affect the moving ability of the dynamic component 170, affect the driving force of the transducer device 120, and affect the output performance of the bone conduction speaker 100. In some embodiments, to enable the single protrusion to provide the compensation force of an appropriate magnitude to the dynamic component 170, the height of the single protrusion along the first direction X is 0.1 mm to 1.2 mm. In some embodiments, to further ensure the output performance of the speaker 100, the height of the single protrusion along the first direction X is 0.3 mm to 0.9 mm.

Please refer to FIG. 2, in some embodiments, a cross-sectional shape of the magnetic conductive element 161 perpendicular to the first direction X is a racetrack shape or a rectangular shape, and the cross-sectional shape of the magnetic conductive element 161 may include two long side portions and two short side portions. In some embodiments, any one of the at least one protrusion 190 includes two independent sub-protrusions, and the two sub-protrusions are respectively arranged on inner side surfaces of two long sides of the cross-sectional shape of the magnetic conductive element 161. The forces provided by the two sub-protrusions to the dynamic component 170 in the second direction Y may cancel each other out, so as to try to avoid movement of the dynamic component 170 in the second direction Y. Through the above arrangement, it can reduce an overall weight of the transducer device 120, and make the protrusion 190 have a strong magnetic property, thereby improving the output performance of the speaker 100. In other embodiments, a second magnet (not shown in the figure) may also include four independent sub-protrusions, the four sub-protrusions may be respectively arranged on inner side surfaces corresponding to the two long side portions and the two short side portions of the static component 160, thereby further enhancing the magnetic property of the protrusion 190, and improving the output performance of the speaker 100.

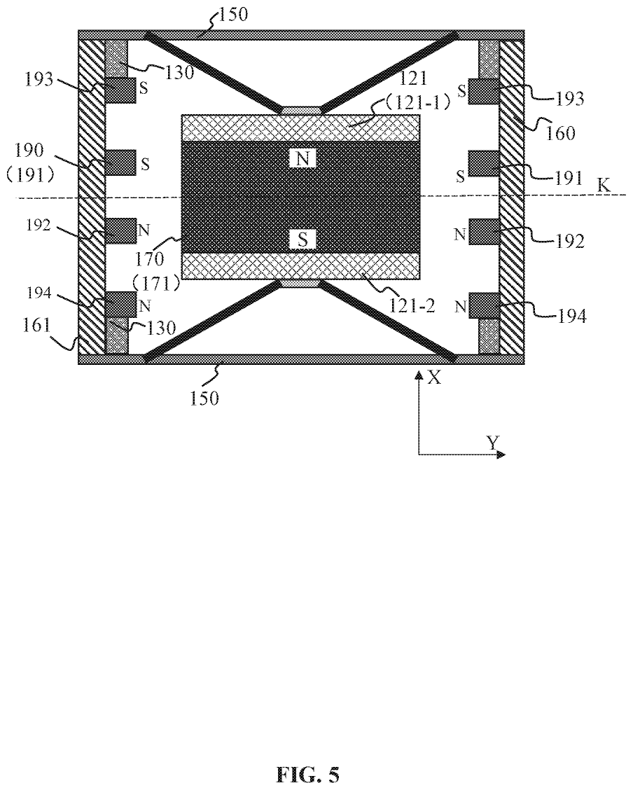

FIG. 5 is a schematic diagram illustrating yet another structure of the transducer device according to some embodiments of the present disclosure. Referring to FIG. 5, in some embodiments, when the dynamic component 170 includes the magnetic conductive plate 121, the magnetic conductive plate 121 is disposed on the surface of the first magnet 171 along the first direction X, and the at least one protrusion 190 may include the first protrusion 191 and a third protrusion 193. The first protrusion 191 and the third protrusion 193 are arranged at an interval in the first direction X. In some embodiments, in the first direction X, the first protrusion 191 and the third protrusion 193 are respectively located at two sides of the magnetic conductive plate 121. The polarity of the side of the first magnet 171 facing the magnetic conductive plate 121 along the first direction X is opposite to the polarity of the side of the first protrusion 191 facing the dynamic component 170 along the second direction Y, so that the first protrusion 191 and the first magnet 171 attract each other. The polarity of the side of the first magnet 171 facing the magnetic conductive plate 121 along the first direction X is opposite to a polarity of a side of the third protrusion 193 facing the dynamic component 170 along the second direction Y, so that the third protrusion 193 and the first magnet 171 attract each other. Merely by way of example, as shown in FIG. 5, the magnetic conductive plate 121 is disposed on the upper side surface of the first magnet 171 along the first direction X. The upper side surface of the first magnet 171 is the N pole, the side of the first protrusion 191 facing the dynamic component 170 along the second direction Y is the S pole, and the side of the third protrusion 193 facing the dynamic component 170 along the second direction Y is an S pole. In some embodiments, the structure and dimensions of the third protrusion 193 may be the same as those of the first protrusion 191. For example, the third protrusion 193 may also be provided with a third boss at a free end thereof facing the first magnet 171 along the second direction Y, and the third boss points to the first magnetic conductive plate 121-1 along the first direction X, or the like. For more information about the third protrusion 193, reference may be made to relevant descriptions of the first protrusion 191, and no further details are provided herein.

When the dynamic component 170 is in the balanced position, the direction of the attractive force of the first protrusion 191 on the upper side surface of the first magnet 171 is downward along the first direction X, and the direction of the attractive force of the third protrusion 193 on the upper side surface of the first magnet 171 is upward along the first direction X. The force of the first protrusion 191 on the dynamic component 170 and the force of the third protrusion 193 on the dynamic component 170 may cancel each other out to maintain the dynamic component 170 in the balanced position.

When the dynamic component 170 moves downward relative to the static component 160 in the first direction X, the distance between the first protrusion 191 and the upper side surface of the first magnet 171 decreases, and the distance between the third protrusion 193 and the upper side surface of the first magnet 171 increases. The force of the first protrusion 191 on the dynamic component 170 increases, and the force of the third protrusion 193 on the dynamic component 170 decreases. Since the direction of the force of the first protrusion 191 on the dynamic component 170 is downward along the first direction X and the direction of the force of the third protrusion 193 on the dynamic component 170 is upward along the first direction X, the direction of the resultant force of the first protrusion 191 and the third protrusion 193 on the dynamic component 170 is downward along the first direction X, which is the same as the moving direction of the dynamic component 170, and points away from the balanced position.

When the dynamic component 170 moves upward relative to the static component 160 in the first direction X, the distance between the first protrusion 191 and the upper side surface of the first magnet 171 increases, and the distance between the third protrusion 193 and the upper side surface of the first magnet 171 decreases. The force of the first protrusion 191 on the dynamic component 170 decreases, and the force of the third protrusion 193 on the dynamic component 170 increases. Since the direction of the force of the first protrusion 191 on the dynamic component 170 is downward along the first direction X and the direction of the force of the third protrusion 193 on the dynamic component 170 is upward along the first direction X, the direction of the resultant force of the first protrusion 191 and the third protrusion 193 on the dynamic component 170 is upward along the first direction X, which is the same as the moving direction of the dynamic component 170, and points away from the balanced position.

In some embodiments, when the dynamic component 170 includes the first magnetic conductive plate 121-1 and the second magnetic conductive plate 121-2, the first magnetic conductive plate 121-1 and the second magnetic conductive plate 121-2 may both have a structure similar to the magnetic conductive plate 121 shown in FIG. 5. Each of the first magnetic conductive plate 121-1 and the second magnetic conductive plate 121-2 respectively corresponds to two protrusions 190. For example, as shown in FIG. 5, the first magnetic conductive plate 121-1 corresponds to the first protrusion 191 and the third protrusion 193, and the second magnetic conductive plate 121-2 corresponds to the second protrusion 192 and a fourth protrusion 194. The interaction relationship between each magnetic conductive plate and the corresponding two protrusions 190 is similar to or the same as the interaction relationship between the magnetic conductive plate 121 and the corresponding first protrusion 191 and third protrusion 193 shown in FIG. 5, and details are not repeated here. For example, the second protrusion 192 may be provided with the second boss at the free end thereof facing the first magnet 171 along the second direction Y, and the second boss points to the second magnetic conductive plate 121-2 along the first direction X. The fourth protrusion 194 may be provided with a fourth boss (not shown in the figure) at a free end thereof facing the first magnet 171 along the second direction Y, and the fourth platform points to the second magnetic conductive plate 121-2 along the first direction X.

In some embodiments, in the first direction X, the first protrusion 191 and the third protrusion 193 are respectively located at two sides of the first magnetic conductive plate 121-1, and the second protrusion 192 and the fourth protrusion 194 are respectively located at two sides of the second magnetic conductive plate 121-1. When the dynamic component 170 is in the balanced position, the first protrusion 191 and the third protrusion 193 are located on one side of the centerline plane of the first magnet 171 parallel to the second direction Y, and the second protrusion 192 and the fourth protrusion 194 are located on the other side of the centerline plane of the first magnet 171 parallel to the second direction Y. In some embodiments, when the first protrusion 191 and the second protrusion 192 are symmetrical based on the first reference plane K, the third protrusion 193 and the fourth protrusion 194 may also be symmetrical based on the first reference plane K. This symmetry may cause the distance from the first protrusion 191 to the first magnetic conductive plate 121-1 to be the same as the distance from the second protrusion 192 to the second magnetic conductive plate 121-2, and the distance from the third protrusion 193 to the first magnetic conductive plate 121-1 to be the same as the distance from the fourth protrusion 194 to the second magnetic conductive plate 121-2. As a result, the forces of the first protrusion 191 and the second protrusion 192 on the first magnet 171 may better cancel each other out, and the forces of the third protrusion 193 and the fourth protrusion 194 on the first magnet 171 may better cancel each other out, to allow the first magnet 171 to be in the balanced position.

When the dynamic component 170 moves relative to the static component 160 in the first direction X, the first restoring force provided by the resilient plate assembly 150 prevents further movement of the dynamic component 170, and the compensation force jointly provided by the protrusion 190 and the magnetic conductive element 161 promotes further movement of the dynamic component 170. That is, the force of the protrusion 190 on the dynamic component 170 may counteract the restoring forces provided by the first magnetic circuit assembly 140 (the magnetic conductive element 161) and the resilient plate assembly 150, reduce the difficulty of the further movement of the dynamic component 170, thereby indirectly improving the driving force of the transducer device 120, and improving the output performance of the speaker 100.

The basic concepts have been described above. Obviously, for a person skilled in the art, the detailed disclosure above is merely by way of example, and does not constitute a limitation on the present disclosure. Although not explicitly stated herein, a person skilled in the art may make various modifications, improvements, and revisions to the present disclosure. Such modifications, improvements, and revisions are suggested in the present disclosure, and therefore such modifications, improvements, and revisions are still within the spirit and scope of the exemplary embodiments of the present disclosure.

Meanwhile, the present disclosure uses specific words to describe the embodiments of the present disclosure. Such as “an embodiment”, “one embodiment”, and/or “some embodiments” refer to that a certain feature, structure, or characteristic is related to at least one embodiment of the present disclosure. Therefore, it should be emphasized and noted that the terms “one embodiment”, “an embodiment”, or “an alternative embodiment” referred to twice or more in different places in the present disclosure do not necessarily refer to the same embodiment. In addition, certain features, structures, or characteristics in one or more embodiments of the present disclosure may be suitably combined.

Similarly, it should be noted that, to simplify the description of the present disclosure and to facilitate understanding of one or more inventive embodiments, in the foregoing description of the embodiments of the present disclosure, various features may sometimes be grouped into a single embodiment, figure, or description thereof. However, such a disclosure approach does not mean that the features required by the subject matter of the present disclosure are more than those mentioned in the claims. In fact, the features of the embodiments are fewer than all the features of the single embodiment disclosed above.

Finally, it should be understood that the embodiments described in the present disclosure are merely by way of illustrating the principles of the embodiments of the present disclosure. Other variations may also fall within the scope of the present disclosure. Therefore, by way of example and not by way of limitation, alternative configurations of the embodiments of the present disclosure may be considered to be consistent with the teachings of the present disclosure. Accordingly, the embodiments of the present disclosure are not limited to the embodiments specifically introduced and described herein.

1. A transducer device, comprising:
a first magnetic circuit assembly, including a dynamic component and a static component, wherein the dynamic component includes a first magnet and a magnetic conductive plate, and the static component includes a magnetic conductive element at least partially surrounding the dynamic component;
a voice coil assembly, wherein the voice coil assembly is fixed to the static component, and the voice coil assembly is at least partially located in a magnetic gap between the static component and the dynamic component, the dynamic component is movable relative to the voice coil assembly and the static component, and the voice coil assembly includes at least one voice coil; and
a resilient plate assembly, configured to connect the dynamic component and the static component, wherein the resilient plate assembly allows the dynamic component to move relative to the static component in a first direction, the first direction is parallel to an axis of the voice coil assembly;
wherein an inner side surface of the magnetic conductive element facing the first magnet is provided with at least one protrusion, the at least one protrusion is arranged in a staggered manner with the voice coil assembly in the first direction, and the at least one protrusion has magnetic permeability;
the magnetic conductive plate is disposed on a surface of the first magnet along the first direction, the at least one protrusion includes a first protrusion and a third protrusion, the first protrusion and the third protrusion are arranged at an interval in the first direction, and in the first direction, the first protrusion and the third protrusion are respectively located at two sides of the magnetic conductive plate.

2. The transducer device of claim 1, wherein a polarity of a side of the first magnet facing the magnetic conductive plate along the first direction is opposite to a polarity of a side of the first protrusion facing the dynamic component along a second direction, the polarity of the side of the first magnet facing the magnetic conductive plate along the first direction is opposite to a polarity of a side of the third protrusion facing the dynamic component along the second direction, and the second direction is perpendicular to the axis of the voice coil assembly.

3. The transducer device of claim 1, wherein, during a movement of the dynamic component relative to the static component, the resilient plate assembly provides a restoring force for restoring the dynamic component to a balanced position; the at least one protrusion cooperates with dynamic component to provide a compensating force for driving the dynamic component to deviate from the balanced position; and the balanced position is a position of the dynamic component relative to the static component when the voice coil assembly is not energized.

4. The transducer device of claim 1, wherein the magnetic conductive plate includes a first magnetic conductive plate and a second magnetic conductive plate, and the first magnetic conductive plate and the second magnetic conductive plate are respectively arranged at two ends of the first magnet along the first direction.

5. (canceled)

6. The transducer device of claim 1, wherein a height of the at least one protrusion along the first direction is 0.1 mm-0.4 mm, a width of the at least one protrusion along a second direction is 0.1 mm-0.5 mm, and the second direction is perpendicular to the axis of the voice coil assembly.

7. The transducer device of claim 6, wherein, in the second direction, a distance between a side surface of the at least one protrusion facing the first magnet and a side surface of the magnetic conductive plate facing the magnetic conductive element is 0.2 mm-0.6 mm.

8. The transducer device of claim 6, wherein, in the second direction, a ratio of a distance between a side surface of the at least one protrusion facing the first magnet and a side surface of the magnetic conductive plate facing the magnetic conductive element to a distance between the inner side surface of the magnetic conductive element and the side surface of the magnetic conductive plate facing the magnetic conductive element is 0.29-0.86.

9. The transducer device of claim 6, wherein, in the second direction, a ratio of the width of the at least one protrusion to a distance between the inner side surface of the magnetic conductive element and a side surface of the magnetic conductive plate facing the magnetic conductive element is 0.14-0.71.

10. The transducer device of claim 4, wherein a ratio of an interval between any two adjacent protrusions of the at least one protrusion in the first direction to the height of the at least one protrusion along the first direction is 0.1-1.

11. The transducer device of claim 10, wherein a free end of the first protrusion facing the first magnet along the second direction is provided with a first boss, and the first boss points to the first magnetic conductive plate along the first direction;
a free end of the third protrusion pointing to the first magnet along the second direction is provided with a third boss, and the third boss points to the first magnetic conductive plate along the first direction.

12. The transducer device of claim 1, wherein the at least one protrusion abuts the voice coil assembly in the first direction.

13. The transducer device of claim 1, wherein the resilient plate assembly includes a first vibration transmission plate and a second vibration transmission plate, the first vibration transmission plate is connected to a first end of the dynamic component along the first direction, the second vibration transmission plate is connected to a second end of the dynamic component along the first direction, the voice coil assembly includes a first voice coil and a second voice coil, the first voice coil is at least partially located in a region of the magnetic gap corresponding to the first end of the dynamic component along the first direction, and the second voice coil is at least partially located in a region of the magnetic gap corresponding to the second end of the dynamic component along the first direction.

14. The transducer device of claim 13, wherein the first vibration transmission plate and the second vibration transmission plate allow the dynamic component to vibrate relative to the static component, and the transducer device has at least one resonance peak within a frequency range of 100 Hz-200 Hz.

15. The transducer device of claim 2, wherein, in the first direction, a moving distance of the dynamic component relative to the balanced position is less than or equal to 1 mm.

16. The transducer device of claim 4, wherein the at least one protrusion further includes a second protrusion and a forth protrusion, the first protrusion, the second protrusion, the third protrusion, and the forth protrusion are arranged at an interval in the first direction;
in the first direction, the first protrusion and the third protrusion are respectively located at two sides of the first magnetic conductive plate, the second protrusion and the forth protrusion are respectively located at two sides of the second magnetic conductive plate;
when the dynamic component is in a balanced position, the first protrusion and the third protrusion are located on one side of a centerline plane of the first magnet parallel to a second direction, and the second protrusion and the fourth protrusion are located on the other side of the centerline plane of the first magnet parallel to the second direction, the balanced position is a position of the dynamic component relative to the static component when the voice coil assembly is not energized, and the second direction is perpendicular to the axis of the voice coil assembly.

17. The transducer device of claim 16, wherein a polarity of the first magnet facing the first magnetic conductive plate in the first direction is opposite to a polarity of the first protrusion facing the first magnet in a second direction, the polarity of the first magnet facing the first magnetic conductive plate in the first direction is opposite to a polarity of the third protrusion facing the first magnet in the second direction;
a polarity of the first magnet facing the second magnetic conductive plate in the first direction is opposite to a polarity of the second protrusion facing the first magnet in the second direction, and the polarity of the first magnet facing the second magnetic conductive plate in the first direction is opposite to a polarity of the forth protrusion facing the first magnet in the second direction.

18. The transducer device of claim 16, wherein, in the first direction, the first protrusion and the second protrusion are located between the first magnetic conductive plate and the second magnetic conductive plate, the first protrusion is closer to the first magnetic conductive plate than the second protrusion, and the second protrusion is closer to the second magnetic conductive plate than the first protrusion.

19. The transducer device of claim 16, wherein a free end of the first protrusion facing the first magnet along the second direction is provided with a first boss, the first boss points to the first magnetic conductive plate along the first direction; a free end of the third protrusion pointing to the first magnet along the second direction is provided with a third boss, and the third boss points to the first magnetic conductive plate along the first direction;
a free end of the second protrusion facing the first magnet along the second direction is provided with a second boss, the second boss points to the second magnetic conductive plate along the first direction; a free end of the forth protrusion pointing to the first magnet along the second direction is provided with a forth boss, and the forth boss points to the second magnetic conductive plate along the first direction.

20. The transducer device of claim 16, wherein the first protrusion and the second protrusion are symmetrical based on a reference plane, and the third protrusion and the fourth protrusion are also symmetrical based on the reference plane.

21. A speaker, comprising a transducer device, the transducer device includes:
a first magnetic circuit assembly, including a dynamic component and a static component, wherein the dynamic component includes a first magnet and a magnetic conductive plate, and the static component includes a magnetic conductive element at least partially surrounding the dynamic component;
a voice coil assembly, wherein the voice coil assembly is fixed to the static component, and the voice coil assembly is at least partially located in a magnetic gap between the static component and the dynamic component, the dynamic component is movable relative to the voice coil assembly and the static component, and the voice coil assembly includes at least one voice coil; and
a resilient plate assembly, configured to connect the dynamic component and the static component, wherein the resilient plate assembly allows the dynamic component to move relative to the static component in a first direction, the first direction is parallel to an axis of the voice coil assembly;
wherein an inner side surface of the magnetic conductive element facing the first magnet is provided with at least one protrusion, the at least one protrusion is arranged in a staggered manner with the voice coil assembly in the first direction, and the at least one protrusion has magnetic permeability;
the magnetic conductive plate is disposed on a surface of the first magnet along the first direction, the at least one protrusion includes a first protrusion and a third protrusion, the first protrusion and the third protrusion are arranged at an interval in the first direction, and in the first direction, the first protrusion and the third protrusion are respectively located at two sides of the magnetic conductive plate.
